(19) United States
(12) Patent Application Publication
(10) Pub. No.: US 2024/0406919 A1
(43) Pub. Date: Dec. 5, 2024

(54) WIRELESS COMMUNICATION METHOD AND WIRELESS TERMINAL AND WIRELESS NETWORK NODE THEREOF

(71) Applicant: ZTE CORPORATION, Shenzhen (CN)

(72) Inventors: Li NIU, Shenzhen (CN); Ting LU, Shenzhen (CN); Yuan GAO, Shenzhen (CN)

(73) Assignee: ZTE CORPORATION, Shenzhen (CN)

(21) Appl. No.: 18/782,158

(22) Filed: Jul. 24, 2024

Related U.S. Application Data
(63) Continuation of application No. PCT/CN2022/103478, filed on Jul. 1, 2022.

(51) Int. Cl. H04W 64/00; H04W 76/28; H04W 80/02

(52) U.S. Cl. CPC H04W 64/00; H04W 76/28; H04W 80/02

(57) ABSTRACT

A wireless communication method for use in a wireless terminal is disclosed. The method comprises performing a global navigation satellite system, GNSS, position if an event occurs.

### CROSS-REFERENCE TO RELATED PATENT APPLICATIONS

This application is a Continuation of PCT Application No. PCT/CN2022/103478, filed Jul. 1, 2022, incorporated herein by reference in its entirety.

### TECHNICAL FIELD

This document is directed generally to wireless communications, and in particular to non-terrestrial communications.

### BACKGROUND

In terrestrial deployments, users and services are so concentrated that a network is mainly located in the city, factory, rural area and so on. In a sparsely populated place, the network deployments are expensive, hard, and even absent. With the advancement of science and technology, there is a great demand of collecting data from and communicating in the remote regions. For example, there may be a demand of collecting meteorological data in a mountain peak or desert.

### SUMMARY

In non-terrestrial deployments, satellites can supply a large coverage in remote regions. The non-terrestrial network deployment may be considered to extend the coverage of the terrestrial network and to further extend the business of cellular network operators. The typical scenario of a non-terrestrial network providing access to user equipment is depicted as FIG. 1.

In FIG. 1, a (n) (NTN) gateway is an earth station or a gateway which is located at the surface of Earth and provides sufficient radio frequency (RF) power and RF sensitivity for accessing the satellite (or High altitude platforms (HAPS), unmanned aircraft system (UAS) platform, etc.). The gateway is a transport network layer (TNL) node. The wireless link between the satellite and the gateway is called feeder link. The wireless link between the satellite and the user equipment (UE) is named service link. The satellite (or UAS platform) generates beams over a given service area bound by its field of view. The footprints of the beams are typically of elliptic shape.

The satellite can be placed into Low-Earth Orbit (LEO), or Geostationary Earth Orbit (GEO). The GEO is the circular orbit at 35,786 km above the Earth's equator and following the direction of the Earth's rotation. An GEO satellite in such an orbit has an orbital period equal to the Earth's rotational period and thus appears motionless, at a fixed position in the sky, to ground observers. The typical beam footprint size of GEO is 200-3500 km.

The LEO is the orbit around the Earth with an altitude between 300 km and 1500 km. An LEO satellite in such an orbit encircles around the earth with the speed of 7.56 km per second. The typical beam footprint size of GEO is 100-1000 km.

In addition, an internet of things (IoT) connectivity also requires a large coverage. The non-terrestrial network deployment may fit the need of the IoT connectivity. Therefore, the NB-IoT (narrow-band IoT) or enhanced Machine Type Communication (eMTC) over the NTN becomes a trend of the technology development.

The present disclosure relates to a wireless communication method for use in a wireless terminal. The method comprises performing a global navigation satellite system, GNSS, position if an event occurs.

Various embodiments may preferably implement the following features:

Preferably or in some embodiments, performing the GNSS position if the event occurs comprises:
performing the GNSS position when being in a connected mode in a gap if the event occurs.

Preferably or in some embodiments, wherein the event comprises at least one of:
a current GNSS position of the wireless terminal is invalid or is going to be invalid,
at least one evaluation period is greater than or equal to a time of the wireless terminal performing the GNSS position, wherein the wireless terminal evaluates a radio link quality in the evaluation period,
at least one discontinuous reception, DRX, cycle is greater than or equal to a time of the wireless terminal performing the GNSS position,
a discontinuous reception, DRX, inactive time or a DRX cycle is greater than or equal to a time of the wireless terminal performing the GNSS position,
a DRX cycle is equal to sf2048,
a DRX onDurationTimer is less than or equal to psf40,
a time of the wireless terminal performing the GNSS position is less than a threshold,
a start type of the GNSS position is a hot start or a warm start,
a data buffer is not empty,
there is subsequent data transmission,
a quality of service, QoS, satisfies delay sensitive requirements, or
an interval between arrival data is smaller than a threshold.

Preferably or in some embodiments, sf2048 is a candidate value configured for a DRX configuration (e.g., for DRX cycle).

Preferably or in some embodiments, a range of sf2048 is from 0 to 2047 (e.g. INTEGER (0 . . . 2047)).

Preferably or in some embodiments, psf40 is a candidate value configured for a DRX configuration (e.g., for DRX onDurationTimer or drx-InactivityTimer).

Preferably or in some embodiments, the gap comprises at least one of a period which is not scheduled for data transmissions, or a DRX inactive time.

Preferably or in some embodiments, the period is a physical downlink control channel gap, a downlink gap or a gap configured for acquiring the GNSS position.

Preferably or in some embodiments, the gap is greater than or equal to a time of the wireless terminal performing the GNSS position.

Preferably or in some embodiments, an occasion of the gap is no later than a current GNSS position of the wireless terminal becomes invalid.

Preferably or in some embodiments, performing the GNSS position if the event occurs comprises:

performing the GNSS position after triggering a radio link failure, RLF, if the event occurs.

Preferably or in some embodiments, the event comprises at least one of:
a current GNSS position of the wireless terminal is invalid or is going to be invalid,
at least one evaluation period is less than a time of the wireless terminal performing the GNSS position, wherein the wireless terminal evaluates a link quality in the evaluation period,
at least one DRX cycle is less than or equal to a time of the wireless terminal performing the GNSS position,
a DRX inactive time or a DRX cycle is less than a time of the wireless terminal performing the GNSS position,
a time of the wireless terminal performing the GNSS position is greater than a threshold,
a start type of the GNSS position is a warm start or cold start,
a data buffer is not empty,
there is subsequent data transmission,
a quality of service, QOS, satisfies delay sensitive requirements, or
an interval between arrival data is less than a threshold.

Preferably or in some embodiments, performing the GNSS position if the event occurs comprises:
performing, if the event occurs, the GNSS position by leaving a connected mode or entering an idle mode.

Preferably or in some embodiments, the event comprises at least one of:
a current GNSS position of the wireless terminal is invalid or is going to be invalid,
a data buffer is empty,
a quality of service, QOS, satisfies delay insensitive requirements,
an interval time between arrival data is greater than a threshold, or
there is no subsequent data transmission.

Preferably or in some embodiments, the wireless communication method further comprises receiving, from a wireless network node, a configuration message of enabling performing the GNSS position when if the event occurs.

Preferably or in some embodiments, the configuration message comprises at least one of a radio link control message or a system information block.

Preferably or in some embodiments, the wireless communication method further comprises receiving, from a wireless network node, configuration information of the gap.

Preferably or in some embodiments, the wireless communication method further comprises receiving, from a wireless network node, an indication or an activation of a DRX cycle, wherein the gap comprises a DRX inactive time.

Preferably or in some embodiments, the configuration information, the indication or the activation of a DRX cycle is comprised in a radio link control message, a system information block, downlink control information or a media access control control element, MAC CE.

Preferably or in some embodiments, the configuration information of the gap comprises at least one of a start time, a duration, a period, an indication of the gap being used for the GNSS position or an activation indication of activating the gap to be used for the GNSS position.

Preferably or in some embodiments, the indication or the activation of the DRX cycle comprises at least one of a start time, a duration, a period, an on-duration, an indication of the DRX cycle being used for the GNSS position or an identity of the DRX cycle.

Preferably or in some embodiments, performing the GNSS position in the gap when in the connected mode if the event occurs comprises at least one of:
starting a timer, wherein a length of the timer is determined based on a time of the wireless terminal performing the GNSS position,
stopping the timer when completing the GNSS position,
triggering an RLF or entering the idle mode if the GNSS position fails, the GNSS position cannot be performed or the timer expires,
triggering a radon access channel, RACH, or a scheduling request, SR, after completing the GNSS position or restoring an uplink synchronization,
generating, after completing the GNSS position, a MAC CE for reporting a validity duration of a new GNSS position acquired by the completed GNSS position,
transmitting the MAC CE in UL sources allocated for subsequent transmissions,
triggering a RACH or an SR for transmitting the MAC CE,
clearing a hybrid automatic repeat request buffer if a current GNSS position of the wireless terminal becomes invalid,
releasing uplink resources if a current GNSS position of the wireless terminal becomes invalid, or
recovering uplink transmissions after completing the GNSS position or restoring an uplink synchronization.

Preferably or in some embodiments, the wireless communication method further comprises transmitting, to a wireless network node, assistance information associated with performing the GNSS position.

Preferably or in some embodiments, the assistance information comprises at least one of:
a time required by the wireless terminal for performing the GNSS position,
a start type of the GNSS position,
a configuration of a gap used for performing the GNSS position,
at least one action performed if a current GNSS position of the wireless terminal is invalid,
an indication of whether the wireless terminal supports performing the GNSS position in a connected mode,
an indication of whether the wireless terminal supports performing the GNSS position in a gap, or
an indication of whether the wireless terminal supports performing a neighbor cell measurement in a connected mode.

Preferably or in some embodiments, the configuration of the gap comprises at least one of a start time, a duration, or an offset before a current GNSS position of the wireless terminal is invalid.

Preferably or in some embodiments, the action comprises at least one of triggering an RLF or staying in the connected mode.

The present disclosure relates to a wireless communication method for use in a wireless network node. The method comprises transmitting, to a wireless terminal, a configuration message of enabling performing a global navigation satellite system, GNSS, position if an event occurs.

Various embodiments may preferably implement the following features:

Preferably or in some embodiments, the configuration message enables performing the GNSS position when being in a connected mode in a gap if the event occurs.

Preferably or in some embodiments, wherein the event comprises at least one of:
a current GNSS position of the wireless terminal is invalid or is going to be invalid,
at least one evaluation period is greater than or equal to a time of the wireless terminal performing the GNSS position, wherein the wireless terminal evaluates a radio link quality in the evaluation period,
at least one discontinuous reception, DRX, cycle is greater than or equal to a time of the wireless terminal performing the GNSS position,
a discontinuous reception, DRX, inactive time or a DRX cycle is greater than or equal to a time of the wireless terminal performing the GNSS position,
a DRX cycle is equal to sf2048,
a DRX onDurationTimer is less than or equal to psf40,
a time of the wireless terminal performing the GNSS position is less than a threshold,
a start type of the GNSS position is a hot start or a warm start,
a data buffer is not empty,
there is subsequent data transmission,
a quality of service, QoS, satisfies delay sensitive requirements, or
an interval between arrival data is smaller than a threshold.

Preferably or in some embodiments, sf2048 is a candidate value configured for a DRX configuration (e.g., for DRX cycle).

Preferably or in some embodiments, a range of sf2048 is from 0 to 2047 (e.g., INTEGER (0 . . . 2047)).

Preferably or in some embodiments, psf40 is a candidate value configured for a DRX configuration (e.g., for DRX onDurationTimer or drx-InactivityTimer).

Preferably or in some embodiments, the gap comprises at least one of a period which is not scheduled for data transmissions, or a DRX inactive time.

Preferably or in some embodiments, the period is a physical downlink control channel gap or a downlink gap or a gap configured for acquiring the GNSS position.

Preferably or in some embodiments, the gap is greater than or equal to a time of the wireless terminal performing the GNSS position.

Preferably or in some embodiments, an occasion of the gap is no later than a current GNSS position of the wireless terminal becomes invalid.

Preferably or in some embodiments, the configuration message enables performing the GNSS position after triggering a radio link failure, RLF, if the event occurs.

Preferably or in some embodiments, the event comprises at least one of:
a current GNSS position of the wireless terminal is invalid or is going to be invalid,
at least one evaluation period is less than a time of the wireless terminal performing the GNSS position, wherein the wireless terminal evaluates a radio link quality in the evaluation period,
at least one DRX cycle is less than or equal to a time of the wireless terminal performing the GNSS position,
a DRX inactive time or a DRX cycle is less than a time of the wireless terminal performing the GNSS position,
a time of the wireless terminal performing the GNSS position is greater than a threshold,
a start type of the GNSS position is a warm start or a cold start,
a data buffer is not empty,
there is subsequent data transmission,
a quality of service, QoS, satisfies delay sensitive requirements, or
an interval between arrival data is less than a threshold.

Preferably or in some embodiments, wherein the configuration message enables performing, if the event occurs, the GNSS position by leaving a connected mode or entering an idle mode.

Preferably or in some embodiments, the event comprises at least one of:
a current GNSS position of the wireless terminal is invalid or is going to be invalid,
a data buffer is empty,
a quality of service, QoS, satisfies delay insensitive requirements,
an interval time between arrival data is greater than a threshold, or
there is no subsequent data transmission.

Preferably or in some embodiments, the configuration message comprises at least one of a radio link control message or a system information block.

Preferably or in some embodiments, the wireless communication method further comprises transmitting, to the wireless terminal, configuration information of the gap.

Preferably or in some embodiments, the wireless communication method further comprises transmitting, to the wireless terminal, an indication or an activation of a DRX cycle, wherein the gap comprises a DRX inactive time.

Preferably or in some embodiments, the configuration information, the indication or the activation of a DRX cycle is comprised in a radio link control message, a system information block, downlink control information or a media access control control element, MAC CE.

Preferably or in some embodiments, the configuration information of the gap comprises at least one of a start time, a duration, a period, an indication of the gap being used for the GNSS position or an activation indication of activating the gap to be used for the GNSS position.

Preferably or in some embodiments, the indication or the activation of the DRX cycle comprises at least one of a start time, a duration, a period, an on-duration, an indication of the DRX cycle being used for the GNSS position or an identity of the DRX cycle.

Preferably or in some embodiments, the wireless communication method further comprises receiving, from the wireless terminal, assistance information associated with performing the GNSS position.

Preferably or in some embodiments, the assistance information comprises at least one of:
a time required by the wireless terminal for performing the GNSS position,
a start type of the GNSS position,
a configuration of a gap used for performing the GNSS position,
at least one action performed if a current GNSS position of the wireless terminal is invalid,
an indication of whether the wireless terminal supports performing the GNSS position in a connected mode,
an indication of whether the wireless terminal supports performing the GNSS position in a gap, or
an indication of whether the wireless terminal supports performing a neighbor cell measurement in a connected mode.

Preferably or in some embodiments, the configuration of the gap comprises at least one of a start time, a duration, or an offset before a current GNSS position of the wireless terminal is invalid.

Preferably or in some embodiments, the action comprises at least one of triggering an RLF or staying in the connected mode.

The present disclosure relates to a wireless communication method for use in a wireless terminal. The method comprises triggering a neighbor cell measurement when being in a connected mode no later than a time of a serving cell stopping serving the wireless terminal.

Various embodiments may preferably implement the following features:

Preferably or in some embodiments, the wireless communication method further comprises receiving, from a wireless network node, a configuration of a start time of the neighbor cell measurement or an offset time, wherein the neighbor cell measurement is performed the offset time before the time of the serving cell stopping serving the wireless terminal.

Preferably or in some embodiments, triggering the neighbor cell measurement when being in the connected mode no later than the time of the serving cell stopping serving the wireless terminal comprises at least one of:
triggering the neighbor cell measurement if a variation of a distance between the wireless terminal and a wireless network node of the serving cell is greater than a first threshold,
triggering the neighbor cell measurement if an increment of a distance between the wireless terminal and a wireless network node of the serving cell is greater than a second threshold,
triggering the neighbor cell measurement if a variation of a timing advance between the wireless terminal and a wireless network node of the serving cell is greater than a third threshold, or
triggering the neighbor cell measurement if an increment of a timing advance between the wireless terminal and a wireless network node of the serving cell is greater than a fourth threshold.

Preferably or in some embodiments, a neighbor cell is detected and a measurement result of the detected neighbor cell is greater than a fifth threshold and the wireless communication method comprises initiating a radio resource control reestablishment based on the neighbor cell measurement.

Preferably or in some embodiments, a validate timer for a non-terrestrial network special system information block is invalid.

Preferably or in some embodiments, a current GNSS position of the wireless terminal becomes invalid.

Preferably or in some embodiments, the wireless communication method further comprises receiving, from a wireless network node, a request for assistance information associated with performing the neighbor cell measurement.

Preferably or in some embodiments, the wireless communication method further comprises transmitting, to a wireless network node, assistance information associated with performing the neighbor cell measurement.

Preferably or in some embodiments, the assistance information indicates at least one of:
the neighbor cell measurement cannot be completed before initiating a radio resource control reestablishment,
a target cell cannot be determined before initiating a radio resource control reestablishment,
measurement results of the neighbor cell measurement become invalid before initiating a radio resource control reestablishment,
a gap between a completion time of the neighbor cell measurement and an initiation time of a radio resource control reestablishment is greater than a sixth threshold, or
a synchronization indication is not received when a timer T310 is running.

The present disclosure relates to a wireless communication method for use in a wireless network node. The method comprises transmitting, to a wireless terminal, a configuration of a start time of a neighbor cell measurement performed by the wireless terminal in a connected mode or an offset time, wherein, based on the configuration, the neighbor cell measurement in the connected mode is performed, by the wireless terminal, the offset time before a time of a serving cell of the wireless terminal stopping serving the wireless terminal.

Various embodiments may preferably implement the following features:

Preferably or in some embodiments, the wireless communication method further comprises transmitting, to the wireless terminal, a request for assistance information associated with performing the neighbor cell measurement.

Preferably or in some embodiments, the wireless communication method further comprises receiving, from the wireless terminal, assistance information associated with performing the neighbor cell measurement.

Preferably or in some embodiments, the assistance information indicates at least one of:
the neighbor cell measurement cannot be completed before initiating a radio resource control reestablishment,
a target cell cannot be determined before initiating a radio resource control reestablishment,
measurement results of the neighbor cell measurement become invalid before initiating a radio resource control reestablishment,
a gap between a completion time of the neighbor cell measurement and an initiation time of a radio resource control reestablishment is greater than a sixth threshold, or
a synchronization indication is not received when a timer T310 is running.

The present disclosure relates to a wireless terminal. The wireless terminal comprising:
a communication unit, and
a processor, configured to perform a global navigation satellite system, GNSS, position if an event occurs.

Various embodiments may preferably implement the following feature:

Preferably or in some embodiments, the processor is further configured to perform any of the aforementioned wireless communication methods.

The present disclosure relates to a wireless network node. The wireless network node comprises:
a communication unit, configured to transmit, to a wireless terminal, a configuration message of enabling performing a global navigation satellite system, GNSS position if an event occurs.

Various embodiments may preferably implement the following feature:

Preferably or in some embodiments, the wireless network node further comprises a processor configured to perform any of the aforementioned wireless communication methods.

The present disclosure relates to a wireless terminal. The wireless terminal comprising:
a communication unit, and
a processor, configured to trigger a neighbor cell measurement when being in a connected mode no later than a time of a serving cell stopping serving the wireless terminal.

Various embodiments may preferably implement the following feature:

Preferably or in some embodiments, the processor is further configured to perform any of the aforementioned wireless communication methods.

The present disclosure relates to a wireless network node. The wireless network node comprises:
a communication unit, configured to transmit, to a wireless terminal, a configuration of a start time of a neighbor cell measurement performed by the wireless terminal in a connected mode or an offset time,
wherein, based on the configuration, the neighbor cell measurement in the connected mode is performed, by the wireless terminal, the offset time before a time of a serving cell of the wireless terminal stopping serving the wireless terminal.

Various embodiments may preferably implement the following feature:

Preferably or in some embodiments, the wireless network node further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a network according to an embodiment of the present disclosure.

FIG. 2 shows an example of a schematic diagram of a wireless terminal according to an embodiment of the present disclosure.

FIG. 3 shows an example of a schematic diagram of a wireless network node according to an embodiment of the present disclosure.

FIG. 4 shows a flowchart of a method according to an embodiment of the present disclosure.

FIG. 5 shows a flowchart of a method according to an embodiment of the present disclosure.

FIG. 6 shows a flowchart of a method according to an embodiment of the present disclosure.

FIG. 7 shows a flowchart of a method according to an embodiment of the present disclosure.

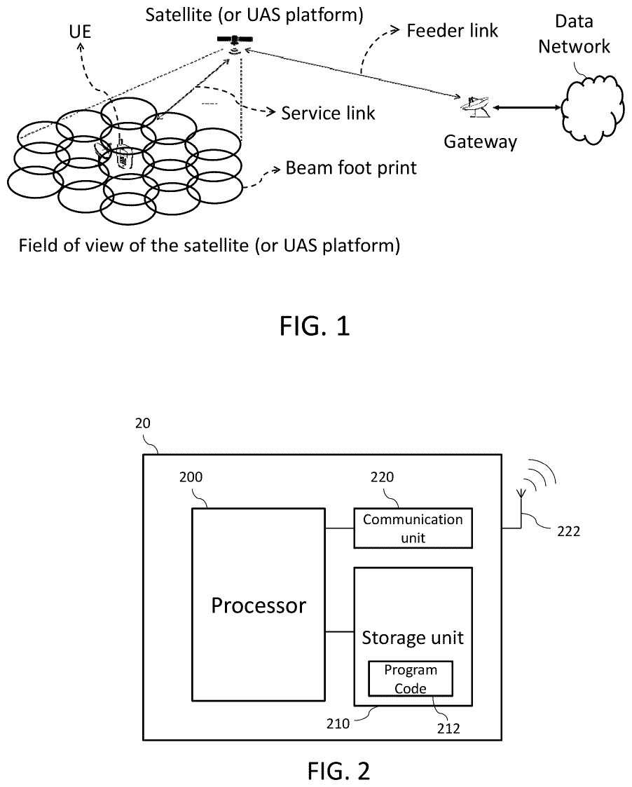

### DETAILED DESCRIPTION

In some embodiments, a global navigation satellite system (GNSS) position and/or an uplink (UL) synchronization of a UE may lose its validity while the UE is in a radio resource control (RRC) connected mode. In order to decrease an interruption time, the UE may acquire the GNSS position and accordingly recovery transmissions. However, the time of the UE performing the GNSS position may last several seconds (e.g., 1 or 2 seconds for hot start or several seconds for warm start, several minutes for cold start). Due to limitations of hardware, when the UE performs the GNSS position, an IoT module in the UE cannot work, the UE could not perform radio link monitoring and a downlink (DL) link failure may happen. Therefore, the UE may need to appropriately select the ways of performing the GNSS position in the RRC connected mode according to the GNSS operation.

Note that the UE performs the GNSS position may mean that the UE determines its GNSS position or performs a GNSS positioning.

In an embodiment, the gNB may enable the UE, via an RRC message or system information block (SIB), to trigger a radio link failure (RLF) when the GNSS position becomes/is invalid. If the gNB configures, via the RRC message or SIB, that the UE can trigger the RLF when the GNSS position becomes invalid, the UE in the connected mode triggers the RLF when the GNSS position becomes invalid. If the gNB does not configure, via the RRC message or SIB, that the UE can trigger the RLF when the GNSS position becomes invalid, the UE in connected mode may need to leave the connected mode (e.g., enter an idle mode) when the GNSS position becomes invalid.

In an embodiment, the gNB may enable the UE, via an RRC message or SIB, to perform the GNSS position by using a gap when the GNSS position becomes or is going to be invalid. In this embodiment, the UE in the (RRC) connected mode can perform the GNSS position in the gap when the GNSS position becomes or is going to be invalid. The gap may be (a) vacant slot(s) which is not scheduled for data transmissions or is discontinuous reception (DRX) inactive time (e.g., DRX off-period).

In an embodiment, the gNB may enable the UE, via an RRC message or SIB, to perform the GNSS position by using a gap when the GNSS position becomes or is going to be invalid and a condition is satisfied. If the gNB configures, via an indication associated with the condition, that the UE can perform the GNSS position by using the gap when GNSS position becomes or is going to be invalid, the UE in connected mode can perform the GNSS position by using the gap when the GNSS position becomes or is going to be invalid and the condition is satisfied. In this embodiment, the gap may be vacant slot(s) which is not scheduled for data transmissions or the DRX inactive time. If the condition is not satisfied, the UE may trigger an RLF when the GNSS position becomes invalid.

In an embodiment, when a condition is satisfied and the GNSS position becomes or is going to be invalid, the UE may use vacant slot(s) which is not scheduled for data transmissions to re-acquire a new GNSS position. In this embodiment, the condition may be that at least one evaluation period is larger than or equal to the time of the UE performing the GNSS position, wherein the evaluation period is a period in which the UE measures/evaluates a radio link quality. The number of evaluation periods is configured by the gNB or N311 (Maximum number of consecutive “in-sync” or “early-in-sync” indications for the PCell received from lower layers) or N310 (Maximum number of consecutive “out-of-sync” or “early-out-of-sync” indications for the PCell received from lower layers). In this embodiment, the condition may be that at least one DRX cycle is larger than or equal to the time of the UE performing the GNSS position, wherein the number of DRX cycles is configured by gNB or determined by the DRX period. The vacant slots could be a physical DL control channel (PDCCH) gap or DL gap or a configured special gap for acquiring the GNSS position. The length of the vacant slots is determined by at least one evaluation period or at least one DRX cycle. Note that the gap may be larger than or equal to the time of the UE performing the GNSS position. In an embodiment, the occasion of the gap is the one that is close to or before the time of the GNSS position becomes invalid.

In an embodiment, when a condition is satisfied and the GNSS position becomes or is going to be invalid, the UE may use the DRX inactive time to re-acquire a new GNSS position. In this embodiment, the condition may be that the DRX inactive time is larger than or equal to a first time threshold, that the DRX cycle is larger than or equal to a second time threshold, or that the DRX cycle is equal to sf2048 and onDurationTimer is less than or equal to psf40. The first time threshold and/or the second time threshold is equal to the time of the UE performing the GNSS position. In addition, the occasion of the DRX is the one that is close to or before the time of the GNSS becoming or going to be invalid.

Note that sf2048 is a candidate value configured for a DRX configuration (e.g., for DRX cycle). In an embodiment, a value of sf2048 corresponds to 2048 sub-frames. In addition, psf40 is a candidate value configured for a DRX configuration (e.g., for DRX onDurationTimer). The psf40 may correspond to 40 PDCCH sub-frames.

In an embodiment, when a condition is satisfied and the GNSS position becomes invalid, the UE may use a gap to re-acquire a new GNSS position. In this embodiment, the condition may be that the time of the UE performing the GNSS position is short, for example, the time of the UE performing the GNSS position is less than a threshold, or that the UE performing a hot start or a warm start for the GNSS position.

In an embodiment, when a condition is satisfied and the GNSS position becomes invalid, the UE may use a gap to re-acquire a new GNSS position. In this embodiment, the condition could be that there is data needed to be or going to be transmitted (e.g., a data buffer is not empty), that there is subsequent data need to be transmitted, that QoS (quality of service) satisfies delay sensitive requirements (e.g. the delay of packet is less than a threshold), or an interval (time) between arrival data is less than a threshold.

In an embodiment, when a condition is satisfied and the GNSS position becomes or is going to be invalid, the UE may trigger the RLF to re-acquire a new GNSS position. In this embodiment, the condition may be that the time of the UE performing the GNSS position has some effect on the RLF, for example, when the UE performs the GNSS position, out-of-sync indication may be triggered. As an alternative or in addition, the condition may be that at least one evaluation period is less than the time of the UE performing the GNSS position, wherein the evaluation period is a period in which the UE measures a radio link quality. As an alternative or in addition, the condition may be that at least one DRX cycle is less than the time of the UE performing the GNSS position, wherein the length of DRX cycle is configured by the gNB or relates to the evaluation period.

In an embodiment, when a condition is satisfied and the GNSS position becomes or is going to be invalid, the UE may trigger the RLF to re-acquire a new GNSS position. In this embodiment, the condition may be that the DRX inactive time is less than a first time threshold, and/or that the DRX cycle is less than a second time threshold. The first time threshold and/or the second time threshold is equal to the time of the UE performing the GNSS position.

In an embodiment, when a condition is satisfied and the GNSS position becomes invalid, the UE may trigger the RLF. In this embodiment, the condition could be that the time of the UE performing the GNSS position is large (for example, the time of the UE performing the GNSS position is higher than a threshold), or that the UE performing a warm start or a cold start for the GNSS position.

In an embodiment, when a condition is satisfied and the GNSS position becomes invalid, UE may trigger the RLF to re-acquire a new GNSS position. In this embodiment, the condition could be that there is data needed to be or going to be transmitted (for example, a data buffer is not empty), that there is subsequent data need to be transmitted, that a QoS satisfies delay sensitive requirements (for example, the delay of packet is less than a threshold), or an interval (time) between arrival data is less than a threshold.

In an embodiment, when a condition is satisfied and the GNSS position becomes invalid, the UE may leave the connected mode or enter an idle mode. In this embodiment, the condition may be that a (data) buffer is empty, that there is no subsequent DL and UL data transmission, that QoS of service does not satisfy a delay sensitive requirement, or that an interval (time) between arrival data is large (e.g., above a threshold).

In some embodiments, if the UE performs the GNSS position by using the gap, the gNB needs to keep alignment with the UE.

In an embodiment, the gNB may indicate the UE the gap and/or activate the UE to be able to perform the GNSS position in the gap. For example, via a media access control control element (MAC CE) or DL control information (DCI) or RRC message or SIB, the gNB may indicate a PDCCH gap or a DL gap. The configuration of the gap could be indicated in the RRC message, the SIB, the MAC CE or the DCI. In an embodiment, the configuration of the gap comprises at least one of a start time, a duration, a period, an index and an indication that the gap is used for the GNSS position. Specifically, the start time may be the effective time of the MAC CE or the DCI, or an offset time after UE receives the MAC CE or the DCI. Furthermore, an activation indication activating the gap may be carried in the MAC CE or the DCI.

In an embodiment, the gNB may indicate UE a DRX cycle or activate the UE to perform the GNSS position by using a DRX cycle. For example, the gNB may indicate UE a DRX cycle via the MAC CE or the DCI or the RRC message or the SIB. The configuration of the DRX cycle may be indicated in the RRC message, the SIB, the MAC CE or the DCI, wherein the configuration comprises at least one of a start time of the DRX cycle, a duration of the DRX cycle, a period of the DRX cycle, an on duration of the DRX cycle and an indication that an inactive time of the DRX cycle is used for GNSS position. Note that a start time of using the DRX inactive time for the GNSS position may be the effective time of the MAC CE or the DCI or an offset time after the UE receives the MAC CE or the DCI. In addition, an identity of the DRX cycle may be carried in the MAC CE or the DCI and/or configured in the RRC message or the SIB. In an embodiment, an activation indication of activating the DRX may be carried in the MAC CE or the DCI.

In some embodiments, the UE may perform certain operations/processes if performing the GNSS position (by using the gap).

In an embodiment, the UE starts a (guard) timer when performing the GNSS position in the gap, wherein a length of the timer is determined based on the time of the UE performing the GNSS position. The timer is stopped if the UE completes the GNSS position. If the UE cannot complete the GNSS position during the time or the timer expires, the UE triggers an RLF or returns to the IDLE mode.

In an embodiment, if the gNB indicates a gap or the UE selects a gap and the UE could not perform GNSS position during the gap, the UE triggers an RLF or returns to the IDLE mode.

In an embodiment, after the UE completes the GNSS position, the UE triggers a random access channel (RACH) (message/process) or a scheduling request (SR). For example, after the UE finishes the GNSS position and/or the UL synchronization is restored, the UE may trigger a RACH. In this embodiment, the configuration of the RACH or the SR is configured in the RRC message or the SIB, wherein the configuration comprises at least one of a frequency or time resource(s) of the RACH or the SR and an indication that the RACH is special/dedicated for the GNSS position.

In an embodiment, after the UE completes/finishes the GNSS position, the UE produces a MAC CE for reporting a GNSS position validity duration. The MAC CE may carry a type of MAC CE indicating the GNSS reporting or an indication indicating that the GNSS position is completed. As an alternative or in addition, the MAC CE may carry a value of the GNSS position validity duration. The value of the GNSS position validity duration may be the remaining time of the GNSS position being valid or an index of the GNSS duration that is configured in the RRC message or the SIB. If the MAC entity has UL resources allocated for a new transmission, the UE may transmit the MAC CE. If the MAC entity has no UL resources allocated for the new transmission, the UE may trigger an SR or a RACH.

In an embodiment, the UE clears a hybrid automatic repeat request (HARQ) buffer and/or releases all UL resources and/or stops UL transmissions when/after the GNSS position becomes invalid.

In an embodiment, the UE may recover UL transmissions when/after the GNSS position becomes valid or the UL synchronization is restored.

In some embodiments, if the invalid GNSS position triggers an RLF or a release, the UE may report certain assistance information to gNB, e.g., to help the gNB making decision.

In an embodiment, the gNB may request the UE to report certain assistance information via an RRC message (e.g., UEInformationRequest). The RRC message may carry an indication of requesting the UE to report the assistance information associated with the GNSS position.

In an embodiment, the UE reports the assistance information to the gNB via an RRC message (e.g., UEInformationResponse or UEAssistanceInformation). The RRC message may carry the assistance information associated with the GNSS position.

In an embodiment, the assistance information may comprise at least one of:
the time that the UE needs to perform the GNSS position, or the GNSS type (such as hot start, warm start);
the desired gap time (e.g., a start time, a duration, an offset before GNSS becomes invalid);
an action performed by the UE when the GNSS position becomes invalid (e.g., triggering RLF and/or staying in connected mode).

In some embodiments, a UE capability associated with the GNSS and/or neighbor cell measurement may be reported to the gNB.

In an embodiment, the information in the UE capability may include at least one of:
an indication of whether the UE supports GNSS operations in the connected mode;
an indication of whether the UE supports GNSS operations using a gap in the connected mode;
a duration needed by the UE to perform the GNSS position and/or the GNSS type (such as hot start, warm start); or
an indication of whether UE supports a condition of the neighbor cell measurement in connected mode based on timing advance, elevation angles and/or a distance.

In some embodiments, if the (NB-IoT) UE is in connected mode and the serving cell is going to stop services, the UE may start a neighbor cell measurement or an RRC reestablishment to facilitate/expedite the UE selecting next cell via the RRC reestablishment.

In an embodiment, before or when the serving cell is going to stop serving the current area at which the UE locates, the UE may start measurements on neighbor cells (i.e., neighbor cell measurements), regardless of the service quality (e.g., RSRP) of the serving cell. The time of starting the neighbor cell measurements can be controlled by the gNB or by the UE. If the exact time of starting the neighbor cell measurements can be controlled by the gNB, the gNB configures the starting time and/or an offset time before the serving cell is going to stop the services.

In an embodiment, if a variation of a distance between the UE and the serving satellite is higher than a first threshold or an increase/increment of the distance between the UE and the serving satellite is higher than a second threshold, the UE may trigger the neighbor cell measurement.

In an embodiment, if a variation of a timing advance between the UE and the serving satellite is higher than a third threshold or an increase/increment of the distance between the UE and the serving satellite is higher than a fourth threshold, the UE may trigger the neighbor cell measurement.

In an embodiment, if a neighbor cell is detected or a measurement result of a neighbor cell is higher than a fifth threshold, and a validate timer for the NTN special SIB expires, the UE may initiate an RRC reestablishment (process/procedure).

In an embodiment, if a neighbor cell is detected or a measurement result of a neighbor cell is higher than a sixth threshold, and the GNSS threshold becomes invalid, the UE may initiate an RRC reestablishment (process/procedure).

In some embodiments, if the condition of triggering the neighbor cell measurement is satisfied too late to allow the UE to finish the neighbor cell measurement before selecting next serving cell, the delay due to the RRC reestablishment procedure cannot be shorten. When the condition of triggering the neighbor cell measurement is satisfied too early, the measurement results may be invalid for the cell selection of subsequent RRC reestablishment if the measurement is one short measurement or the UE may need to perform another measurement for the RRC reestablishment. In other words, the condition of triggering the intra-frequency or inter-frequency measurement(s) may not be appropriately set.

In an embodiment, the gNB may request the UE to report certain assistance information via an RRC message (e.g., UEInformationRequest). The RRC message may carry an indication of requesting the UE to report the assistance information associated with the GNSS position.

In an embodiment, the UE may report the assistance information to the gNB via an RRC message (e.g., UEInformationResponse, UEAssistanceInformation, RRC reestablishment request or RRC reestablishment complete). The RRC message may carry the assistance information associated with the neighbor cell measurement (results).

In an embodiment, the condition of triggering the neighbor cell measurement may be too late or too early. The condition being too late means that the UE cannot complete/finish the neighbor cell measurement or detect a suitable cell before an RRC reestablishment. The condition being too early means that neighbor cell measurement results become invalid before the RRC reestablishment or that there is a long gap between the time of the UE finishing/completing the neighbor cell measurement and the time of the UE triggering the RRC reestablishment.

In an embodiment, the triggering of the RRC reestablishment is too late. The triggering is too late means that the UE cannot receive a synchronization indication during a timer T310 is running.

FIG. 2 relates to a schematic diagram of a wireless terminal 20 according to an embodiment of the present disclosure. The wireless terminal 20 may be a user equipment (UE), a mobile phone, a laptop, a tablet computer, an electronic book or a portable computer system and is not limited herein. The wireless terminal 20 may include a processor 200 such as a microprocessor or Application Specific Integrated Circuit (ASIC), a storage unit 210 and a communication unit 220. The storage unit 210 may be any data storage device that stores a program code 212, which is accessed and executed by the processor 200. Embodiments of the storage unit 210 include but are not limited to a subscriber identity module (SIM), read-only memory (ROM), flash memory, random-access memory (RAM), hard-disk, and optical data storage device. The communication unit 220 may a transceiver and is used to transmit and receive signals (e.g., messages or packets) according to processing results of the processor 200. In an embodiment, the communication unit 220 transmits and receives the signals via at least one antenna 222 shown in FIG. 2.

In an embodiment, the storage unit 210 and the program code 212 may be omitted and the processor 200 may include a storage unit with stored program code.

The processor 200 may implement any one of the steps in exemplified embodiments on the wireless terminal 20, e.g., by executing the program code 212.

The communication unit 220 may be a transceiver. The communication unit 220 may as an alternative or in addition be combining a transmitting unit and a receiving unit configured to transmit and to receive, respectively, signals to and from a wireless network node (e.g., a base station).

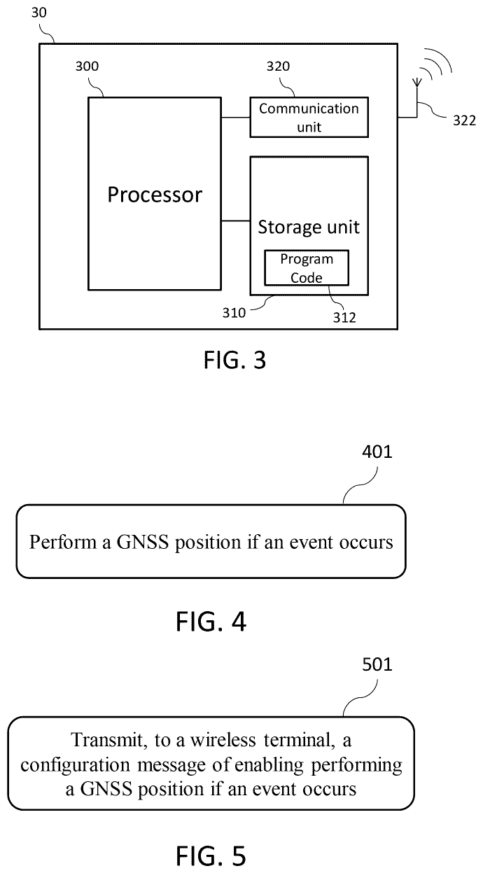

FIG. 3 relates to a schematic diagram of a wireless network node 30 according to an embodiment of the present disclosure. The wireless network node 30 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 30 may comprise (perform) at least one network function such as an access and mobility management function (AMF), a session management function (SMF), a user place function (UPF), a policy control function (PCF), an application function (AF), etc. The wireless network node 30 may include a processor 300 such as a microprocessor or ASIC, a storage unit 310 and a communication unit 320. The storage unit 310 may be any data storage device that stores a program code 312, which is accessed and executed by the processor 300. Examples of the storage unit 310 include but are not limited to a SIM, ROM, flash memory, RAM, hard-disk, and optical data storage device. The communication unit 320 may be a transceiver and is used to transmit and receive signals (e.g., messages or packets) according to processing results of the processor 300. In an example, the communication unit 320 transmits and receives the signals via at least one antenna 322 shown in FIG. 3.

In an embodiment, the storage unit 310 and the program code 312 may be omitted. The processor 300 may include a storage unit with stored program code.

The processor 300 may implement any steps described in exemplified embodiments on the wireless network node 30, e.g., via executing the program code 312.

The communication unit 320 may be a transceiver. The communication unit 320 may as an alternative or in addition be combining a transmitting unit and a receiving unit configured to transmit and to receive, respectively, signals to and from a wireless terminal (e.g., a user equipment or another wireless network node).

FIG. 4 shows a flowchart of a method according to an embodiment of the present disclosure. The method shown in FIG. 4 may be used in a wireless terminal (e.g., UE) and comprises the following step:

Step 401: Perform a GNSS position if an event occurs.

In this embodiment, if an event occurs, the wireless terminal may perform a GNSS position.

In an embodiment, if the event occurs, the wireless terminal in a (n) (RRC) connected mode performs the GNSS position in a gap. In this embodiment, the event may comprise at least one of:
a current GNSS position of the wireless terminal is invalid or is going to be invalid,
at least one evaluation period is greater than or equal to a time of the wireless terminal performing the GNSS position, wherein the wireless terminal evaluates a radio link quality in the evaluation period,
at least one DRX cycle is greater than or equal to a time of the wireless terminal performing the GNSS position,
a DRX inactive time or a DRX cycle is greater than or equal to a time of the wireless terminal performing the GNSS position,
a DRX cycle is equal to sf2048,
a DRX onDurationTimer is less than or equal to psf40,
a time of the wireless terminal performing the GNSS position is less than a threshold,
a start type of the GNSS position is a hot start or a warm start,
a data buffer is not empty,
there is subsequent data transmission,
a quality of service, QoS, satisfying delay sensitive requirements, or
an interval between arrival data is smaller than a threshold.

In an embodiment, the gap may comprise at least one of a period which is not scheduled for data transmissions, or a DRX inactive time. For example, the period is a PDCCH gap, a DL gap or a gap configured for acquiring the GNSS position. Note that the gap may be greater than or equal to a time of the wireless terminal performing the GNSS position.

In an embodiment, an occasion of the gap is no later than (i.e., before or when) a current GNSS position of the wireless terminal becomes invalid.

In an embodiment, if the event occurs, the wireless terminal performing the GNSS position after triggering an RLF. In this embodiment, the event may comprise the event comprises at least one of:
a current GNSS position of the wireless terminal is invalid or is going to be invalid,
at least one evaluation period is less than a time of the wireless terminal performing the GNSS position, wherein the wireless terminal evaluates a link quality in the evaluation period,
at least one DRX cycle is less than or equal to a time of the wireless terminal performing the GNSS position,
a DRX inactive time or a DRX cycle is less than a time of the wireless terminal performing the GNSS position,
a time of the wireless terminal performing the GNSS position is greater than a threshold,
a start type of the GNSS position is a warm start or cold start,
a data buffer is not empty,
there is subsequent data transmission,
a QoS satisfying delay sensitive requirements, or
an interval between arrival data is less than a threshold.

In an embodiment, if the event occurs, the wireless terminal may perform the GNSS position by leaving a connected mode or entering an idle mode. In this embodiment, the event may comprise at least one of:
a current GNSS position of the wireless terminal is invalid or is going to be invalid,
a data buffer is empty,
a QoS satisfies delay insensitive requirements,
an interval time between arrival data is greater than a threshold, or
there is no subsequent data transmission.

In an embodiment, the wireless terminal receives a configuration message of enabling performing the GNSS position if the event occurs from a wireless network node (e.g., BS, gNB). For instance, the configuration message comprises at least one of a radio link control message or a system information block.

In an embodiment, the wireless terminal may receive a configuration information of the gap from the wireless network node.

In an embodiment, the wireless terminal may receive an indication or an activation of a DRX cycle, wherein the gap comprises a DRX inactive time from the wireless network node.

In an embodiment, the configuration information, the indication or the activation of a DRX cycle is comprised in an RRC message, a SIB, DCI or a MAC CE.

In an embodiment, the configuration information of the gap comprises at least one of a start time, a duration, a period, an indication of the gap being used for the GNSS position or an activation indication of activating the gap to be used for the GNSS position.

In an embodiment, the indication or the activation of the DRX cycle comprises at least one of a start time, a duration, a period, an on-duration, an indication of the DRX cycle being used for the GNSS position or an identity of the DRX cycle.

In an embodiment, the wireless terminal performs the GNSS position in the gap when in the connected mode if the event occurs by performing at least one of:
starting a timer, wherein a length of the timer is determined based on a time of the wireless terminal performing the GNSS position,
stopping the timer when completing the GNSS position,
triggering an RLF or entering the idle mode if the GNSS position fails, the GNSS position cannot be performed or the timer expires,
triggering a radon access channel, RACH, or a scheduling request, SR, after completing the GNSS position or restoring an uplink synchronization,
generating, after completing the GNSS position, a MAC CE for reporting a validity duration of a new GNSS position acquired by the completed GNSS position,
transmitting the MAC CE in UL sources allocated for subsequent transmissions,
triggering a RACH or an SR for transmitting the MAC CE,
clearing a hybrid automatic repeat request buffer if a current GNSS position of the wireless terminal becomes invalid,
releasing uplink resources if a current GNSS position of the wireless terminal becomes invalid, or
recovering uplink transmissions after completing the GNSS position or restoring an uplink synchronization.

In an embodiment, the wireless terminal transmits assistance information associated with (performing) the GNSS position to the wireless network node. For example, the assistance information comprises at least one of:
a time required by the wireless terminal for performing the GNSS position,
a start type of the GNSS position,
a (desired) configuration of a gap used for performing the GNSS position,
at least one action performed if a current GNSS position of the wireless terminal is invalid,
an indication of whether the wireless terminal supports performing the GNSS position in a connected mode,
an indication of whether the wireless terminal supports performing the GNSS position in a gap, or
an indication of whether the wireless terminal supports performing a neighbor cell measurement in a connected mode.

In an embodiment, the (desired) configuration of the gap comprises at least one of a start time, a duration, or an offset before a current GNSS position of the wireless terminal is invalid.

In an embodiment, the action performed if the current GNSS position of the wireless terminal is invalid comprises at least one of triggering an RLF or staying in the connected mode.

FIG. 5 shows a flowchart of a method according to an embodiment of the present disclosure. The method shown in FIG. 5 may be used in a wireless network node (e.g., BS or gNB) and comprises the following step:

Step 501: Transmit, to a wireless terminal, a configuration message of enabling performing a GNSS position if an event occurs.

Specifically, the wireless network node transmits a configuration message to a wireless terminal (e.g., UE), to enable (a function of) performing a GNSS position if an event occurs.

In an embodiment, the configuration message enables (the function of) performing the GNSS position when being in a connected mode in a gap if the event occurs. For instance, the event comprises at least one of:
a current GNSS position of the wireless terminal is invalid or is going to be invalid,
at least one evaluation period is greater than or equal to a time of the wireless terminal performing the GNSS position, wherein the wireless terminal evaluates a radio link quality in the evaluation period,
at least one DRX cycle is greater than or equal to a time of the wireless terminal performing the GNSS position,
a DRX inactive time or a DRX cycle is greater than or equal to a time of the wireless terminal performing the GNSS position,
a DRX cycle is equal to sf2048,
a DRX onDurationTimer is less than or equal to psf40,
a time of the wireless terminal performing the GNSS position is less than a threshold,
a start type of the GNSS position is a hot start or a warm start,
a data buffer is not empty,
there is subsequent data transmission,
a QoS satisfies delay sensitive requirements, or
an interval between arrival data is smaller than a threshold.

In an embodiment, the gap comprises at least one of a period which is not scheduled for data transmissions, or a DRX inactive time.

In an embodiment, the period is a PDCCH gap or a DL gap or a gap configured for acquiring the GNSS position.

In an embodiment, the gap is greater than or equal to a time of the wireless terminal performing the GNSS position.

In an embodiment, an occasion of the gap is no later than (i.e., before or when) a current GNSS position of the wireless terminal becomes invalid.

In an embodiment, the configuration message enables (the function of) performing the GNSS position after triggering an RLF if the event occurs. In this embodiment, the event comprises at least one of:
a current GNSS position of the wireless terminal is invalid or is going to be invalid,
at least one evaluation period is less than a time of the wireless terminal performing the GNSS position, wherein the wireless terminal evaluates a radio link quality in the evaluation period,
at least one DRX cycle is less than or equal to a time of the wireless terminal performing the GNSS position,
a DRX inactive time or a DRX cycle is less than a time of the wireless terminal performing the GNSS position,
a time of the wireless terminal performing the GNSS position is greater than a threshold,
a start type of the GNSS position is a warm start or a cold start,
a data buffer is not empty,
there is subsequent data transmission,
a QoS satisfies delay sensitive requirements, or
an interval between arrival data is less than a threshold.

In an embodiment, the configuration message enables (the function of) performing, if the event occurs, the GNSS position by leaving a connected mode or entering an idle mode. In this embodiment, the event may comprise at least one of:
a current GNSS position of the wireless terminal is invalid or is going to be invalid,
a data buffer is empty,
a QoS satisfies delay insensitive requirements,
an interval time between arrival data is greater than a threshold, or
there is no subsequent data transmission.

In an embodiment, the configuration message comprises at least one of an RRC message or a SIB.

In an embodiment, the wireless network node transmits configuration information of the gap to the wireless terminal.

In an embodiment, the wireless network node transmits an indication or an activation of a DRX cycle, wherein the gap comprises a DRX inactive time.

In an embodiment, the configuration information, the indication or the activation of a DRX cycle is comprised in an RRC message, a SIB, DCI or a MAC CE.

In an embodiment, the configuration information of the gap comprises at least one of a start time, a duration, a period, an indication of the gap being used for the GNSS position or an activation indication of activating the gap to be used for the GNSS position.

In an embodiment, the indication or the activation of the DRX cycle comprises at least one of a start time, a duration, a period, an on-duration, an indication of the DRX cycle being used for the GNSS position or an identity of the DRX cycle.

In an embodiment, the wireless network node receives assistance information associated with (performing) the GNSS position.

In an embodiment, the assistance information comprises at least one of:
a time required by the wireless terminal for performing the GNSS position,
a start type of the GNSS position,
a (desired) configuration of a gap used for performing the GNSS position,
at least one action performed if a current GNSS position of the wireless terminal is invalid,
an indication of whether the wireless terminal supports performing the GNSS position
in a connected mode,
an indication of whether the wireless terminal supports performing the GNSS position in a gap, or
an indication of whether the wireless terminal supports performing a neighbor cell measurement in a connected mode.

In an embodiment, the (desired) configuration of the gap comprises at least one of a start time, a duration, or an offset before a current GNSS position of the wireless terminal is invalid.

In an embodiment, the action performed if a current GNSS position of the wireless terminal is invalid comprises at least one of triggering an RLF or staying in the connected mode.

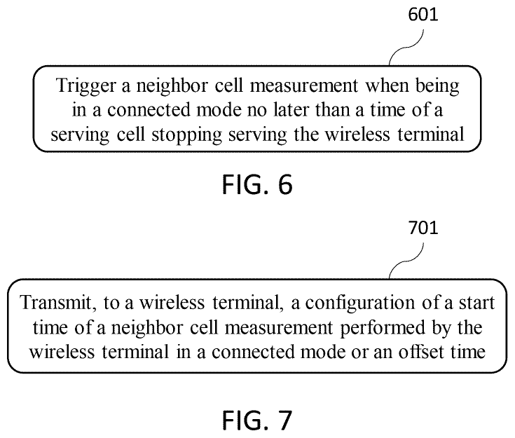

FIG. 6 shows a flowchart of a method according to an embodiment of the present disclosure. The method shown in FIG. 6 may be used in a wireless terminal (e.g., UE) and comprises the following step:

Step 601: Trigger a neighbor cell measurement when being in a connected mode no later than a time of a serving cell stopping serving the wireless terminal.

In this embodiment, the wireless terminal in the connected mode performs/triggers a neighbor cell measurement no later than (before or when) a time of a serving cell stopping serving the wireless terminal.

In an embodiment, the wireless terminal receives a configuration of a start time of the neighbor cell measurement or an offset time from a wireless network node (e.g., BS or gNB), wherein the neighbor cell measurement is performed the offset time before the time of the serving cell stopping serving the wireless terminal.

In an embodiment, the wireless terminal triggers the neighbor cell measurement when being in the connected mode no later than the time of the serving cell stopping serving the wireless terminal by performing at least one of:
triggering the neighbor cell measurement if a variation of a distance between the wireless terminal and a wireless network node of the serving cell is greater than a first threshold,
triggering the neighbor cell measurement if an increment of a distance between the wireless terminal and a wireless network node of the serving cell is greater than a second threshold,
triggering the neighbor cell measurement if a variation of a timing advance between the wireless terminal and a wireless network node of the serving cell is greater than a third threshold, or
triggering the neighbor cell measurement if an increment of a timing advance between the wireless terminal and a wireless network node of the serving cell is greater than a fourth threshold.

In an embodiment, a neighbor cell is detected and a measurement result of the detected neighbor cell is greater than a fifth threshold. In this embodiment, the wireless terminal initiates an RRC reestablishment based on the neighbor cell measurement. In addition, a validate timer for a non-terrestrial network special system information block is invalid and/or a current GNSS position of the wireless terminal becomes invalid (when or before initiating the RRC reestablishment).

In an embodiment, the wireless terminal receives a request for assistance information associated with performing the neighbor cell measurement from the wireless network node.

In an embodiment, the wireless terminal transmits assistance information associated with performing the neighbor cell measurement to the wireless network node.

In an embodiment, the assistance information indicates at least one of:
the neighbor cell measurement cannot be completed before initiating a radio resource control reestablishment,
a target cell cannot be determined before initiating a radio resource control reestablishment,
measurement results of the neighbor cell measurement become invalid before initiating a radio resource control reestablishment,
a gap between a completion time of the neighbor cell measurement and an initiation time of a radio resource control reestablishment is greater than a sixth threshold, or
a synchronization indication is not received when a timer T310 is running.

FIG. 7 shows a flowchart of a method according to an embodiment of the present disclosure. The method shown in FIG. 7 may be used in a wireless network node (e.g., BS or gNB) and comprises the following step:

Step 701: Transmit, to a wireless terminal, a configuration of a start time of a neighbor cell measurement performed by the wireless terminal in a connected mode or an offset time.

Specifically, the wireless network node transmits a configuration associated with a neighbor cell measurement performed by the wireless terminal in a connected mode. The configuration may comprise a start time of the neighbor cell measurement. As an alternative or in addition, the configuration may comprise an offset time, wherein based on the configuration, the neighbor cell measurement is performed, by the wireless terminal, the offset time before a time of a serving cell of the wireless terminal stopping serving the wireless terminal.

In an embodiment, the wireless network node transmits a request for assistance information associated with performing the neighbor cell measurement to the wireless terminal.

In an embodiment, the wireless network node receives assistance information associated with performing the neighbor cell measurement from the wireless terminal.

In an embodiment, the assistance information indicates/comprises at least one of:
the neighbor cell measurement cannot be completed before initiating a radio resource control reestablishment,
a target cell cannot be determined before initiating a radio resource control reestablishment,
measurement results of the neighbor cell measurement become invalid before initiating the radio resource control reestablishment,
a gap between a completion time of the neighbor cell measurement and an initiation time of a radio resource control reestablishment is greater than a sixth threshold, or
a synchronization indication is not received when a timer T310 is running.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a wireless terminal, the wireless communication method comprising:
performing a global navigation satellite system (GNSS) position if an event occurs.

2. The wireless communication method of claim 1, wherein performing the GNSS position if the event occurs comprises:
performing the GNSS position when being in a connected mode in a gap if the event occurs,
wherein the event comprises at least one of:
a current GNSS position of the wireless terminal is invalid or is going to be invalid,
at least one evaluation period is greater than or equal to a time of the wireless terminal performing the GNSS position, wherein the wireless terminal evaluates a radio link quality in the evaluation period,
at least one discontinuous reception (DRX) cycle is greater than or equal to a time of the wireless terminal performing the GNSS position,
a DRX inactive time or a DRX cycle is greater than or equal to a time of the wireless terminal performing the GNSS position,
a DRX cycle is equal to sf2048,
a DRX onDurationTimer is less than or equal to psf40,
a time of the wireless terminal performing the GNSS position is less than a threshold,
a start type of the GNSS position is a hot start or a warm start,
a data buffer is not empty,
there is subsequent data transmission,
a quality of service, QoS, satisfies delay sensitive requirements, or
an interval between arrival data is less than a threshold.

3. The wireless communication method of claim 2, wherein the gap comprises at least one of a period which is not scheduled for data transmissions, or a DRX inactive time.

4. The wireless communication method of claim 3, wherein the period is a physical downlink control channel gap, a downlink gap or a gap configured for acquiring the GNSS position.

5. The wireless communication method of claim 3, wherein the gap is greater than or equal to a time of the wireless terminal performing the GNSS position, or
wherein an occasion of the gap is no later than a current GNSS position of the wireless terminal becomes invalid.

6. The wireless communication method of claim 1, wherein performing the GNSS position if the event occurs comprises:
performing the GNSS position after triggering a radio link failure (RLF) if the event occurs,
wherein the event comprises at least one of:
a current GNSS position of the wireless terminal is invalid or is going to be invalid,
at least one evaluation period is less than a time of the wireless terminal performing the GNSS position, wherein the wireless terminal evaluates a link quality in the evaluation period,
at least one DRX cycle is less than or equal to a time of the wireless terminal performing the GNSS position,
a DRX inactive time or a DRX cycle is less than a time of the wireless terminal performing the GNSS position,
a time of the wireless terminal performing the GNSS position is greater than a threshold,
a start type of the GNSS position is a warm start or cold start,
a data buffer is not empty,
there is subsequent data transmission,
a quality of service (QOS) satisfies delay sensitive requirements, or
an interval between arrival data is less than a threshold.

7. The wireless communication method of claim 1,
wherein performing the GNSS position if the event occurs comprises:
performing, if the event occurs, the GNSS position by leaving a connected mode or entering an idle mode,
wherein the event comprises at least one of:
a current GNSS position of the wireless terminal is invalid or is going to be invalid,
a data buffer is empty,
a quality of service (QOS) satisfies delay insensitive requirements,
an interval time between arrival data is greater than a threshold, or
there is no subsequent data transmission.

8. The wireless communication method of claim 1, further comprising:
receiving, from a wireless network node, a configuration message of enabling performing the GNSS position if the event occurs,
wherein the configuration message comprises at least one of a radio link control message or a system information block.

9. The wireless communication method of claim 2, further comprising:
receiving, from a wireless network node, configuration information of the gap, or
receiving, from a wireless network node, an indication or an activation of a DRX cycle, wherein the gap comprises a DRX inactive time.

10. The wireless communication method of claim 9, wherein the configuration information, the indication or the activation of a DRX cycle is comprised in a radio link control message, a system information block, downlink control information or a media access control control element (MAC CE),
wherein the configuration information of the gap comprises at least one of a start time, a duration, a period, an indication of the gap being used for the GNSS position or an activation indication of activating the gap to be used for the GNSS position,
wherein the indication or the activation of the DRX cycle comprises at least one of a start time, a duration, a period, an on-duration, an indication of the DRX cycle being used for the GNSS position or an identity of the DRX cycle.

11. The wireless communication method of claim 2, wherein performing the GNSS position in the gap when in the connected mode if the event occurs comprises at least one of:
starting a timer, wherein a length of the timer is determined based on a time of the wireless terminal performing the GNSS position,
stopping the timer when completing the GNSS position,
triggering an RLF or entering the idle mode if the GNSS position fails, the GNSS position cannot be performed or the timer expires,
triggering a radon access channel (RACK) or a scheduling request (SR) after completing the GNSS position or restoring an uplink synchronization,
generating, after completing the GNSS position, a MAC CE for reporting a validity duration of a new GNSS position acquired by the completed GNSS position,
transmitting the MAC CE in UL sources allocated for subsequent transmissions,
triggering a RACH or an SR for transmitting the MAC CE,
clearing a hybrid automatic repeat request buffer if a current GNSS position of the wireless terminal becomes invalid,
releasing uplink resources if a current GNSS position of the wireless terminal becomes invalid, or
recovering uplink transmissions after completing the GNSS position or restoring an uplink synchronization.

12. The wireless communication method of an of claim 1, further comprising: transmitting, to a wireless network node, assistance information associated with performing the GNSS position.

13. A wireless communication method for use in a wireless network node, the wireless communication method comprising:
transmitting, to a wireless terminal, a configuration message of enabling performing a global navigation satellite system (GNSS) position if an event occurs.

14. The wireless communication method of claim 13, wherein the configuration message enables performing the GNSS position when being in a connected mode in a gap if the event occurs,
wherein the event comprises at least one of:
a current GNSS position of the wireless terminal is invalid or is going to be invalid,
at least one evaluation period is greater than or equal to a time of the wireless terminal performing the GNSS position, wherein the wireless terminal evaluates a radio link quality in the evaluation period,
at least one discontinuous reception (DRX) cycle is greater than or equal to a time of the wireless terminal performing the GNSS position,
a DRX inactive time or a DRX cycle is greater than or equal to a time of the wireless terminal performing the GNSS position,
a DRX cycle is equal to sf2048,
a DRX onDurationTimer is less than or equal to psf40,
a time of the wireless terminal performing the GNSS position is less than a threshold,
a start type of the GNSS position is a hot start or a warm start,
a data buffer is not empty,
there is subsequent data transmission,
a quality of service (QOS) satisfies delay sensitive requirements, or
an interval between arrival data is smaller than a threshold.

15. The wireless communication method of claim 14, wherein the gap comprises at least one of a period which is not scheduled for data transmissions, or a DRX inactive time;
wherein the period is a physical downlink control channel gap or a downlink gap or a gap configured for acquiring the GNSS position;
wherein the gap is greater than or equal to a time of the wireless terminal performing the GNSS position; and
wherein an occasion of the gap is no later than a current GNSS position of the wireless terminal becomes invalid.

16. The wireless communication method of claim 13, wherein the configuration message enables performing the GNSS position after triggering a radio link failure (RLF) if the event occurs,
wherein the event comprises at least one of:
a current GNSS position of the wireless terminal is invalid or is going to be invalid,
at least one evaluation period is less than a time of the wireless terminal performing the GNSS position, wherein the wireless terminal evaluates a radio link quality in the evaluation period,
at least one DRX cycle is less than or equal to a time of the wireless terminal performing the GNSS position,
a DRX inactive time or a DRX cycle is less than a time of the wireless terminal performing the GNSS position,
a time of the wireless terminal performing the GNSS position is greater than a threshold,
a start type of the GNSS position is a warm start or a cold start,
a data buffer is not empty,
there is subsequent data transmission,
a quality of service (QOS) satisfies delay sensitive requirements, or
an interval between arrival data is less than a threshold.

17. The wireless communication method of claim 13, wherein the configuration message enables performing, if the event occurs, the GNSS position by leaving a connected mode or entering an idle mode,
wherein the event comprises at least one of:
a current GNSS position of the wireless terminal is invalid or is going to be invalid,
a data buffer is empty,
a quality of service (QOS) satisfies delay insensitive requirements,
an interval time between arrival data is greater than a threshold, or
there is no subsequent data transmission.

18. The wireless communication method of claim 13, further comprising:
receiving, from the wireless terminal, assistance information associated with performing the GNSS position.

19. A wireless terminal, comprising:
a communication unit, and
a processor, configured to perform a global navigation satellite system (GNSS) position if an event occurs.

20. A wireless network node, comprising:
a communication unit, configured to transmit, to a wireless terminal, a configuration message of enabling performing a global navigation satellite system (GNSS) position if an event occurs.
